(19) United States
(12) Patent Application Publication
(10) Pub. No.: US 2022/0012732 A1
(43) Pub. Date: Jan. 13, 2022

(54) CONTROL METHOD, SERVER, AND RECORDING MEDIUM

(71) Applicant: Panasonic Intellectual Property Corporation of America, Torrance, CA (US)

(72) Inventors: Yuji UNAGAMI, Osaka (JP); Junji MICHIYAMA, Fukuoka (JP); Junichiro SOEDA, Nara (JP); Yuuki HIROSE, Osaka (JP); Tetsuji FUCHIKAMI, Osaka (JP); Motoji OHMORI, Osaka (JP)

(21) Appl. No.: 17/484,506

(22) Filed: Sep. 24, 2021

Related U.S. Application Data
(63) Continuation of application No. PCT/JP2020/016443, filed on Apr. 14, 2020.
(60) Provisional application No. 62/834,757, filed on Apr. 16, 2019.

(51) Int. Cl. G06Q 20/38; G06Q 20/40; G06Q 20/20

(52) U.S. Cl. CPC G06Q 20/3825; G06Q 20/201; G06Q 20/401; G06Q 20/38215

(57) ABSTRACT

A control method is executed by one server out of a plurality of servers, each managing one of a plurality of distributed ledgers. The control method includes receiving first transaction data from a measured-value server over a network, the measured-value server providing, for each of one or more parameters for determining a price for a variable-price service, a measured value that corresponds to the parameter, and the first transaction data including the one or more parameters, the measured value, and a location and a time where and when the measured value is obtained; and transferring the received first transaction data to other servers different from the one server out of the plurality of servers and storing a first block including the first transaction data into a first distributed ledger managed by the one server.

### CROSS REFERENCE TO RELATED APPLICATIONS

This is a continuation application of PCT International Application No. PCT/JP2020/016443 filed on Apr. 14, 2020, designating the United States of America, which is based on and claims priority of U.S. Provisional Patent Application No. 62/834,757 filed on Apr. 16, 2019. The entire disclosures of the above-identified applications, including the specifications, drawings and claims are incorporated herein by reference in their entirety.

### FIELD

The present disclosure relates to a control method, a server, and a recording medium.

### BACKGROUND

Patent Literature (PTL) 1 discloses a system for dynamically adjusting prices for services on the basis of a utilization parameter.

### CITATION LIST

### Patent Literature

PTL: Specification of U.S. Patent Application Publication No. 2013/0246207

### SUMMARY

### Technical Problem

In services for which prices vary according to measured values of parameters, the recording of measured values serving as a basis to decide prices is required in order to prove correctness of the decided prices. There is however a problem of difficulty in managing the records of measured values.

In view of this, the present disclosure provides a control method and the like that enable effective management of records of measured values.

### Solution to Problem

A control method according to one aspect of the present disclosure is a control method that is executed by one server out of a plurality of servers each managing a distributed ledger. The control method includes receiving first transaction data from a measured-value server over a network, the measured-value server providing, for each of one or more parameters for determining a price for a variable-price service, a measured value that corresponds to the parameter, and the first transaction data including the one or more parameters, the measured value, and a location and a time when and where the measured value is obtained, and transferring the first transaction data received to other servers out of the plurality of servers and storing a first block including the first transaction data into a first distributed ledger managed by the one server.

These general and specific aspects may be implemented using a system, an apparatus, an integrated circuit, a computer program, or a computer-readable recording medium such as a CD-ROM, or any combination of systems, apparatuses, integrated circuits, computer programs, or computer-readable recording media.

### Advantageous Effects

The control method according to the present disclosure enables effective management of records of the measured values.

### BRIEF DESCRIPTION OF DRAWINGS

These and other advantages and features will become apparent from the following description thereof taken in conjunction with the accompanying drawings, by way of non-limiting examples of embodiments disclosed herein.

FIG. 1 is a block diagram schematically illustrating a configuration of a price decision system according to one exemplary embodiment.

FIG. 2 is a block diagram schematically illustrating a configuration of a server according to the embodiment.

FIG. 3 is an explanatory drawing schematically illustrating price-decision transaction data according to the embodiment.

FIG. 4 is an explanatory drawing schematically illustrating measured-value transaction data according to the embodiment.

FIG. 5 is an explanatory drawing schematically illustrating price transaction data according to the embodiment.

FIG. 6 is an explanatory drawing schematically illustrating payment transaction data according to the embodiment.

FIG. 7 is a sequence diagram illustrating a first example of processing performed in the price decision system according to the embodiment.

FIG. 8 is a sequence diagram illustrating a second example of the processing performed in the price decision system according to the embodiment.

FIG. 9 is a sequence diagram illustrating a third example of the processing performed in the price decision system according to the embodiment.

FIG. 10 is a sequence diagram illustrating the third example of the processing performed in the price decision system according to the embodiment.

FIG. 11 is a sequence diagram illustrating a first example of processing for generating the measured-value transaction data according to the embodiment.

FIG. 12 is a sequence diagram illustrating a second example of the processing for generating the measured-value transaction data according to the embodiment.

FIG. 13 is a block diagram schematically illustrating a configuration of a price decision system according to Variation 2.

FIG. 14 is a block diagram schematically illustrating a configuration of a price decision system according to Variation 3.

FIG. 15 is a flowchart of processing performed by a server according to Variation 4.

FIG. 16 is a block diagram schematically illustrating a configuration of the server according to Variation 4.

FIG. 17 is an explanatory drawing illustrating a data structure a block chain.

FIG. 18 is an explanatory drawing illustrating a data structure of transaction data.

### DESCRIPTION OF EMBODIMENT

Underlying Knowledge Forming Basis of the Present Disclosure

In relation to a technique related to dynamic adjustment of prices for services, disclosed in the Background section, the inventors have found the following problem.

In mechanisms according to conventional techniques such as disclosed in PTL 1, prices for services to be provided are decided by auction or by predicting demand for the services. Such variable-price services require that adjusted prices and/or measured values serving as a basis to decide the prices be recorded in order to verify whether the adjusted prices are appropriate or inappropriate. It is also required to prevent tampering with records of the adjusted prices.

It is, however, difficult to effectively manage records of measured values by simply recording the measured values. For example, if measured values are acquired from a plurality of measured-value servers for providing measured values in order to ensure correctness of the measured values, the measured values received from the respective measured-value servers have to be recorded, and this increases storage capacity by the number of measured-value servers. Thus, there is a problem of increasing power consumption by the recording. Alternatively, for example, if measured values are recorded on an individual basis, breakage of a memory may result in a loss of measured values recorded on the broken memory.

In view of this, the present disclosure provides a control method and the like that enable effective management of records of measured values.

In order to solve such a problem, the control method according to one exemplary embodiment of the present disclosure is a control method that is executed by one server out of a plurality of servers each managing a distributed ledger. The control method includes receiving first transaction data from a measured-value server over a network, the measured-value server providing, for each of one or more parameters for determining a price for a variable-price service, a measured value that corresponds to the parameter, and the first transaction data including the one or more parameters, the measured value, and a location and a time when and where the measured value is obtained, and transferring the first transaction data received to other servers out of the plurality of servers and storing a first block including the first transaction data into a first distributed ledger managed by the one server.

With this, the first transaction data including the measured value(s) is transferred to the other servers, and the first block including the first transaction data is stored into the first distributed ledger. Accordingly, for example, even if measured values are provided from a plurality of measured-value servers, it is possible to collectively manage the measured values. Besides, a loss of records of measured values can be reduced because the first transaction data is transferred to the other servers. Accordingly, it is possible to effectively manage records of measured values.

For example, the storing of the first block into the first distributed ledger may include executing a consensus algorithm together with the other servers and storing the first block into the first distributed ledger.

With this, the storing of the first block into the first distributed ledger is implemented through the execution of the consensus algorithm. Accordingly, the control method according to the present disclosure can properly manage the measured values with more ease through the execution of the consensus algorithm.

For example, the control method may further include verifying an electronic signature associated with the measured-value server and correctness of the first transaction data in the first transaction data received, and when the verifying of the electronic signature and the correctness of the first transaction data is successful, executing the storing of the first block into the first distributed ledger.

With this, the storing of the first block in the first distributed ledger is implemented through the verification of the correctness. Accordingly, the control method according to the present disclosure can more properly manage the measured values through the verification of the correctness.

For example, the control method may further include receiving second transaction data from a distribution server over the network, the distribution server offering the variable-price service, and the second transaction data including a first price presented on a terminal of a user who uses the variable-price service, a first measured value used to decide the first price, and a first location and a first time where and when the first measured value is obtained, and transferring the second transaction data received to the other servers and storing a second block including the second transaction data into the first distributed ledger.

With this, the second transaction data including the first price decided is transferred to the other servers, and the second block including the second transaction data is stored into the first distributed ledger. Accordingly, it is possible to properly manage the first price.

For example, the control method may further include determining whether the first price included in the second transaction data received matches or mismatches with a measured value associated with the first location and the first time in the first transaction data stored in the first distributed ledger, storing the second block into the first distributed ledger when it is determined that the first price matches with the measured value, and skipping storing of the second block into the first distributed ledger when it is determined that the first price does not match with the measured value.

With this, the second block is not stored into the first distributed ledger when it is determined that the first price does not match with the measured value. Accordingly, it is possible to reduce the possibility that the second transaction data including an inappropriate first price is stored into the first distributed ledger. Since the second transaction data including an inappropriate first price is not stored into the first distributed ledger, it is possible to reduce the storage capacity of the first distributed ledger.

For example, the first transaction data may be received at different times. A plurality of first transaction data items received at the different times, the first transaction data items each being the first transaction data, may include a plurality of measured values obtained at different locations and at different times. The control method may further include temporarily storing the plurality of first transaction data items received into a predetermined storage area in succession, the determining being performed after the temporarily storing of the plurality of first transaction data items, and when it is determined in the determining that the first price matches with the measured value, specifying, from among the plurality of first transaction data items stored temporarily in the predetermined storage area, a first transaction data item that includes a second measured value corresponding to the first location and the first time that are included in the second transaction data, and the storing of the first block includes storing a first block including the first transaction data specified, into the first distributed ledger.

With this, only for a first transaction data item corresponding to the second measured value used to calculate the price out of the plurality of first transaction data items, the first block including the first transaction data item is stored into the first distributed ledger. That is, the first transaction data items that include measured values that are not used to calculate the price are not stored into the first distributed ledger. Accordingly, it is possible to reduce the storage capacity of the first distributed ledger.

For example, the control method may further include transmitting presentation information for causing the terminal to present the first price, to the terminal over the network, receiving, from the terminal, third transaction data that includes an amount of token related to payment of the first price presented in the presentation information, and transferring the third transaction data received to the other servers and storing a third block including the third transaction data into the first distributed ledger.

With this, the third transaction data including the amount of tokens related to payment of the first price presented is transferred to the other servers, and the third block including the third transaction data is stored into the first distributed ledger. Accordingly, it is possible to properly manage the amount of tokens that have been paid.

For example, the control method may further include receiving fourth transaction data from a distribution server over the network, the distribution server providing the variable-price service, the fourth transaction data including the parameter and a price-decision algorithm that includes the parameter and that is for determining the price, and transferring the fourth transaction data received to the other servers and storing a fourth block including the fourth transaction data into the first distributed ledger.

With this, the fourth transaction data including the price decision algorithm is transferred to the other servers, and the fourth block including the fourth transaction data is stored into the first distributed ledger. Accordingly, it is possible to properly manage the price decision algorithm.

A server according to one exemplary embodiment of the present disclosure is one server out of a plurality of servers each managing a distributed ledger, and includes a processor and a memory. Using the memory, the processor receives first transaction data from a measured-value server over a network, the measured-value server providing a measured value corresponding to each of one or more parameters for deciding a price for a variable-price service, and the first transaction data including the one or more parameters, the measured value corresponding to each of the one or more parameters, and a location and a time where and when the measured value is obtained, and transfers the first transaction data received to other servers different from the one server out of the plurality of servers, and store a first block including the first transaction data into a first distributed ledger managed by the one server.

With this, the first transaction data including the measured value is transferred to the other servers, and the first block including the first transaction data is stored into the first distributed ledger. Thus, for example, even if measured values are provided from a plurality of measured-value servers, it is possible to collectively manage the measured values. Since the first transaction data is transferred to the other servers, it is possible to reduce the possibility that records of measured values are lost. Accordingly, it is possible to effectively manage records of measured values.

A program recording medium according to one exemplary embodiment of the present disclosure is a non-transitory computer-readable recording medium for use in a computer, the recording medium having a computer program recorded thereon for causing the computer to execute the above-described control method.

The above-described embodiment achieves effects to those of the above-described control method.

These general and specific aspects may be implemented using a system, an apparatus, an integrated circuit, a computer program, or a computer-readable recording medium such as a CD-ROM, or any combination of systems, apparatuses, integrated circuits, computer programs, or computer-readable recording media.

Hereinafter, one exemplary embodiment is described in greater detail with reference to the accompanying drawings.

The exemplary embodiment described below shows a general or specific example. The numerical values, shapes, materials, elements, the arrangement and connection of the elements, steps, the processing order of the steps etc. shown in the following exemplary embodiment are mere examples, and therefore do not limit the scope of the appended claims and their equivalents. Therefore, among the elements in the following exemplary embodiment, those that are not recited in any one of the independent claims are described as optional elements.

### EMBODIMENT

The present embodiment describes, for example, a price decision system and a method of controlling the price decision system that enable effective management of records of measured values serving as a basis to decide prices in services for which prices vary according to measured values of parameters (hereinafter, referred to as “variable-price services”). Examples of the variable-price services include vehicle distribution services, such as a taxi service and a share riding service, and services for selling performance tickets, such as movie tickets, theatre tickets, or concert tickets.

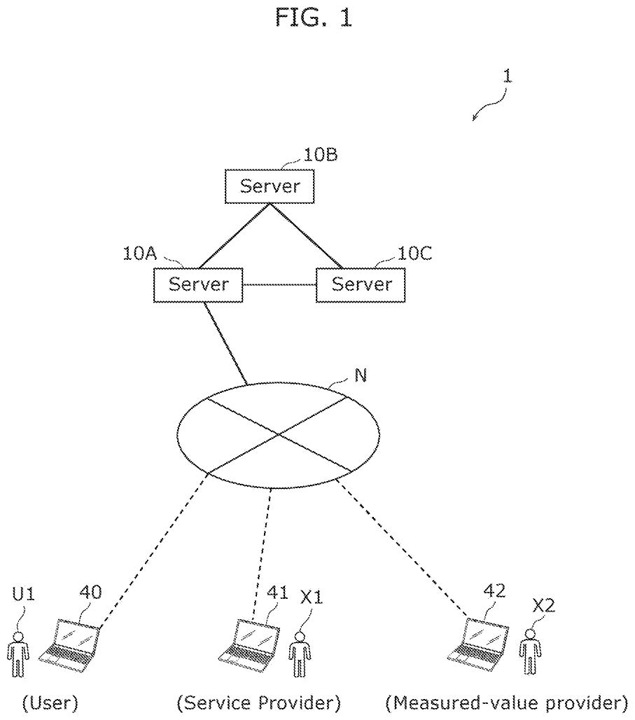

FIG. 1 is a block diagram schematically illustrating a configuration of price decision system 1 according to the present embodiment.

As illustrated in FIG. 1, price decision system 1 includes servers 10A, 10B, and 10C and terminals 40, 41, and 42. Each device included in price decision system 1 is communicably connected to the other devices over network N. Network N may be configured of any communication circuit or any network and include, for example, the Internet or carrier networks for mobile phones. Servers 10A, 10B, and 10C are hereinafter also referred to as “servers such as 10A”.

Servers 10A, 10B, and 10C manage data regarding varying prices, using a plurality of distributed ledgers. Server 10A is one of a plurality of servers 10A, 10B, and 10C. Server 10A is one of a plurality of servers 10A, 10B, and 10C that possess distributed ledgers. The distributed ledger possessed by server 10A stores various types of transaction data regarding procedures or processing for transactions of a transaction currency (e.g., price decision, measured values obtained by measurement, decided prices, and payment). Server 10A that has received the aforementioned transaction data accepts a procedure or processing for transactions of tokens. The tokens as used herein refer to value information managed using the distributed ledgers, and may correspond to or be exchangeable with, for example, money, points (royalties), gift certificates, or coupons.

Servers 10B and 10C each are a device having the same function as server 10A and operate independently of server 10A. Note that the number of servers is not limited to three, and may be any plural number. Alternatively, the servers such as 10A are communicably connected to one another, and may be connected over network N.

Here, the case where server 10A out of the servers such as 10A receives transaction data from terminal 40 or the like and transmits a notification to terminal 40 or the like is described by way of example, but other servers (server 10B or 10C) may perform the above-described processing.

Terminal 40 is a terminal device possessed by user U1. Terminal 40 is a terminal for making an application for using a service to terminal 41 of service provider X1 or for paying a fee for using a service (i.e., a price for a service) to the servers such as 10A. For example, terminal 40 receives input of an application for using a variable-price service. Based on the received input, terminal 40 generates application information including the input and transmits the generated application information to terminal 41 of service provider X1 over network N. The application information may include service identification information for identifying the service applied by user U1, a location where the service is to be used, and the time of reception of the input. Note that the location where the service is to be used may be the location of terminal 40 that is detected by a position sensor of terminal 40 when the input is received. The position sensor may, for example, be a global positioning system (GPS) receiver.

Terminal 40 may further receive presentation information for causing terminal 40 to present a price for the service received from the servers such as 10A, and may present the price for the service based on the received presentation information. That is, the presentation information is information for causing a display (not shown) of terminal 40 to present (display) the price for the service. Based on the received presentation information, terminal 40 may further generate transaction data (also referred to as “payment transaction data” or “third transaction data”) for paying the amount of tokens corresponding to the price indicated by the presentation information and transmit the generated transaction data to the servers such as 10A. Specifically, terminal 40 generates transaction data that includes the amount of tokens related to payment of the price indicated by the presentation information, as the payment transaction data.

Terminal 40 may, for example, be a personal computer, a smartphone, or a tablet.

Terminal 41 is a terminal device possessed by service provider X1 that provides a service with varying prices. Terminal 41 is one example of a distribution server. Terminal 41 is a terminal for transmitting, to the servers such as 10A, a price decision algorithm including a parameter for deciding the price for the service with varying prices, and transmitting the decided price for the service with varying prices. Terminal 41 stores the price decision algorithm and the parameter in a memory (not shown) of terminal 41, such as a non-volatile memory.

For example, terminal 41 generates transaction data that includes the service with varying prices (also referred to as “price-decision transaction data” or “fourth transaction data”) and transmits the generated transaction data to the servers such as 10A. Specifically, terminal 41 generates transaction data that includes the price decision algorithm and the parameters included in the price decision algorithm, as the price-decision transaction data.

Terminal 41 may further receive application information from terminal 40 over network N. Terminal 41 that has received the application information determines specific information for specifying a measured value of the parameter, which is necessary to decide the price, on the basis of the application information in order to deicide the price presented on terminal 40 of the user using the service with varying prices. For example, in the case where the parameter is the weather at the location where the service is to be used, this location and the time of reception of the input for applying for the variable-price service are determined as the specific information for specifying the measured value, i.e., the value indicating the weather at that location and at that time.

Then, terminal 41 transmits, to the servers such as 10A, the determined specific information as request information for requesting the servers such as 10A to transmit the measured value. Terminal 41 that has received the measured value indicated by the request information from the servers such as 10A decides a price corresponding to the received measured value, using the received measured value and the price-decision algorithm stored in the memory. In this way, terminal 41 generates, for example, transaction data (hereinafter also referred to as “price transaction data” or “second transaction data”) that includes a first price, which is the decided price, and transmits the generated transaction data to the servers such as 10A. Specifically, terminal 41 generates, as the price transaction data, transaction data that includes the decided first price, a first measured value that is the measured value used to decide the first price, a first location where the first measured value has been measured, and a first time at which the first measured value has been measured.

Note that terminal 41 may transmit the request information to terminal 42 that manages measured values and may receive a measured value from terminal 42.

Terminal 41 may, for example, be a personal computer, a smartphone, or a tablet.

Terminal 42 is a terminal device possessed by measured-value provider X2 that provides measured values. Terminal 42 is one example of a measured-value server. Terminal 42 provides measured values to the servers such as 10A. For example, terminal generates transaction data (hereinafter also referred to as “measured-value transaction data” or “first transaction data”) that includes a measured value, and transmits the generated transaction data to the servers such as 10A. Specifically, terminal 42 generates, as the measured-value transaction data, transaction data that includes a measured value corresponding to the parameter included in the price decision algorithm, and a location and a time where and when the measured value has been obtained. Note that the measured value is a value based on a detection result obtained by a sensor (not shown) or based on an input from a measurer. The measurement of the measured value is repeatedly made at a plurality of locations and at regular time intervals (e.g., every five minutes or every ten minutes).

Terminal 42 may, for example, be a personal computer, a smartphone, or a tablet.

Terminal 40 may further has the function of terminal 41, or may have the function of terminal 42. Similarly, terminal 41 may have the function of terminal 40, or may have the function of terminal 42. Similarly, terminal 42 may have the function of terminal 40, or may have the function of terminal 41. Each of terminals 40 to 42 operates independently of the other terminals.

Price decision system 1 may include a plurality of service providers. That is, price decision system 1 may include, in addition to terminal 41 possessed by first service provider X1, a terminal possessed by a second service provider (not shown). Similarly, price decision system 1 may include a plurality of measured-value providers. That is, price decision system 1 may include, in addition to terminal possessed by first measured-value provider X2, a terminal possessed by a second measured-value provider (not shown). Price decision system 1 may include three or more service providers and three or more measured-value providers.

Hereinafter, the configuration of the servers such as 10A in price decision system 1 will be described in detail.

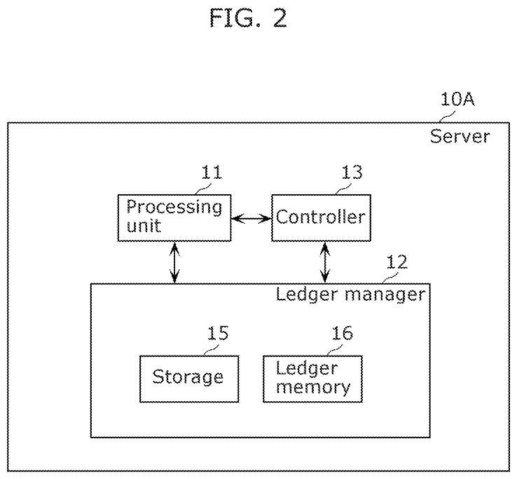

FIG. 2 is a block diagram schematically illustrating a configuration of server 10A according to the present embodiment.

As illustrated in FIG. 2, server 10A includes processing unit 11, ledger manager 12, and controller 13. The aforementioned functional units of server 10A may be implemented by, for example, a central processing unit (CPU) executing programs using a memory.

Processing unit 11 is a processing unit that manages various types of information, using a distributed ledger. When transaction data has been received from a device in price decision system 1 or when transaction data generated by controller 13 has been acquired, processing unit 11 provides ledger manager 12 with the received or acquired transaction data to store the transaction data into the distributed ledger. The transaction data includes the price-decision transaction data, the measured-value transaction data, the price transaction data, and the payment transaction data. The details of each transaction data will be described later.

Ledger manager 12 is a processing unit that manages the distributed ledger. Specifically, when transaction data has been received, ledger manager 12 transfers the received transaction data to other servers and also stores the received transaction data into the distributed ledger. For example, ledger manager 12 receives measured-value transaction data from terminal 42, transfers the received measured-value transaction data to other servers 10B and 10C different from server 10A out of the plurality of servers 10A, 10B, and 10C, and stores a first block including measured-value transaction data into the distributed ledger stored in ledger memory 16. Ledger manager 12 also receives price transaction data from terminal 41, transfers the received price transaction data to the other servers 10B and 10C, and stores a second block including the price transaction data into the distributed ledger stored in ledger memory 16. Ledger manager 12 further receives payment transaction data from terminal 40, transfers the received payment transaction data to the other servers 10B and 10C, and stores a third block including the payment transaction data into the distributed ledger stored in ledger memory 16. Ledger manager 12 further receives price-decision transaction data from terminal 41, transfers the received price-decision transaction data to the other servers 10B and 10C, and stores a fourth block including the price-decision transaction data into the distributed ledger stored in ledger memory 16.

In this way, ledger manager 12 stores the transaction data provided from processing unit 11 into the distributed ledger. The distributed ledger stores transaction data from past to present. In the distributed ledger, the above-described transaction data is managed such that the transaction data is protected from tampering, using a characteristic that it is difficult to tamper with information recorded in the distributed ledger.

Ledger manager 12 includes storage 15 and ledger memory 16.

Storage 15 is a processing unit that stores, in ledger memory 16, new transaction data to be stored into the distributed ledger. Storage 15 stores new transaction data in ledger memory 16 in a format corresponding to the type of the distributed ledger. Storage 15 also transmits and receives communication data to and from storages 15 of the other servers out of the servers such as 10A and causes the other servers to store the aforementioned new transaction data into their respective ledger memories 16.

Storage 15 that has received the transaction data verifies whether the format of the transaction data is correct or incorrect and whether an electronic signature is valid or invalid. In this way, storage 15 verifies the electronic signature and the correctness of the transaction data in the transaction data. When the verification of the electronic signature and the correctness of the transaction data is successful, storage 15 executes storing of the transaction data into the distributed ledger.

For example, in the case where the distributed ledger is a block chain, storage 15 generates a block that includes the new transaction data and stores the generated block into ledger memory 16 in synchronization with the servers such as 10A. For example, in the case of storing the first block into the distributed ledger, storage 15 executes a consensus algorithm together with the other servers 10B and 10C and stores the first block into the distributed ledger. In the case of storing the second block into the distributed ledger, for example, storage 15 executes a consensus algorithm together with the other servers 10B and 10C and stores the second block into the distributed ledger. In the case of storing the third block into the distributed ledger, for example, storage 15 executes a consensus algorithm together with the other servers 10B and 10C and stores the third block into the distributed ledger. In the case of storing the fourth block into the distributed ledger, for example, storage 15 executes a consensus algorithm together with the other servers 10B and 10C and stores the fourth block into the distributed ledger.

Ledger memory 16 is a memory that stores the distributed ledger. The distributed ledger stored in ledger memory 16 stores one or more transaction data items and is managed using a characteristic, such as a hash value, so as to make tampering with the transaction data difficult. The detail thereof will be described later.

Note that the distributed ledger may, for example, be a block chain, and this case is described by way of example, but it is also possible to adopt a distributed ledger having a different format (e.g., IOTA or a hash graph). Note that, in the case of storing new data into the distributed ledger, a consensus algorithm (e.g., practical byzantine fault tolerance (PBFT), proof of work (PoW), or proof of stake (PoS)) may be executed or may not be executed. One example of distributed ledger technology that does not execute a consensus algorithm is Hyperledger Fabric.

Controller 13 determines whether the price decided by terminal 41 matches or mismatches with the measured value serving as a basis for terminal 41 to decide the price. Then, in accordance with the result of the determination, controller 13 controls ledger manager 12 to store or not store the second block into the distributed ledger. Specifically, when it is determined that the price matches with the measured value, controller 13 causes ledger manager 12 to store the second block into the distributed ledger, and when it is determined that the price does not match with the measured value, controller 13 controls ledger manager 12 not to store the second block into the distributed ledger.

For example, if the first measured value associated with the price transaction data is equal to a specific measured value that is specified at the first location and at the first time from the measured-value transaction data already recorded in the distributed ledger, controller 13 may determine that the price matches with the measured value. In this case, if the first measured value differs from the specific measured value, controller 13 may determine that the price does not match with the measured value. When the first measured value falls within a predetermined range of errors based on a specific measured value as a reference, controller 13 may determine that the price matches with the measured value, and if the first measured value does not fall within the predetermined range of errors, controller 13 may determine that the price does not match with the measured value.

The following description is given of (1) the price-decision transaction data, (2) the measured-value transaction data, (3) the price transaction data, and (4) the payment transaction data, which are various types of transaction data stored in the distributed ledger of processing unit 11.

### (1) Price-Decision Transaction Data

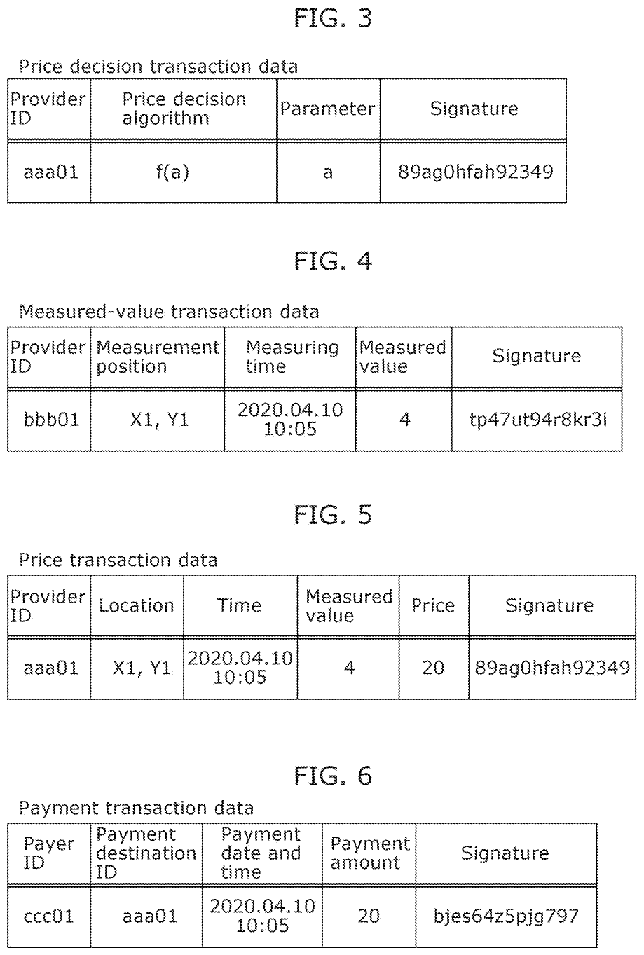

FIG. 3 is an explanatory drawing schematically illustrating the price-decision transaction data according to the present embodiment. The price-decision transaction data is generated by terminal 41 possessed by service provider X1 and transmitted to the servers such as 10A, for example when service provider X1 starts offering a variable-price service or when a price decision algorithm for a variable-price service is altered.

As illustrated in FIG. 3, the price-decision transaction data includes a provider ID, a price-decision algorithm, a parameter, and a signature.

The provider ID is an identifier for uniquely identifying a provider that provides the variable-price service.

The price-decision algorithm is an algorithm for dynamically deciding a price for the variable-price service in accordance with the parameter. The price-decision algorithm may, for example, be a function expressed by the parameter.

The parameter is a parameter (variable) used in the price-decision algorithm. For example, the parameter may be the weather, demand for the variable-price service, or supply of the variable-price service, or may be any combination of two or more of the weather, demand, and supply.

In the case where the parameter indicates the weather, for example, a value of 5 may indicate very fine weather, a value of 4 may indicate fine weather, a value of 3 may indicate cloudy weather, a value of 2 may indicate rainy weather (soft rain), and a value of 1 may indicate rainy weather (strong rain). For example, a price decided by the price-decision algorithm may have a tendency to drop with increasing value (measured value) of the parameter, which indicates the weather. That is, a price decided by the price-decision algorithm may have a tendency to drop as the weather is getting better. On the contrary, a price decided by the price-decision algorithm may have a tendency to rise with increasing value (measured value) of the parameter, which indicates the weather. That is, a price decided by the price-decision algorithm may have a tendency to rise as the weather is getting better.

In the case where the parameter indicates the weather, the weather may be expressed by, for example, rainfall. For example, a price decided by the price-decision algorithm may have a tendency to drop with increasing value (measured value) indicating a rainfall. On the contrary, a price decided by the price-decision algorithm may have a tendency to rise with increasing value (measured value) indicating a rainfall.

In the case where the parameter indicates demand, for example, a price decided by the price-decision algorithm may have a tendency to rise with increasing value indicating the demand for the variable-price service. In the case where the parameter indicates supply, for example, a price decided by the price-decision algorithm may have a tendency to drop with increasing value indicating the supply of the variable-price service.

The signature is an electronic signature signed by a device or human that has generated the price-decision transaction data.

The price-decision transaction data illustrated in FIG. 3 indicates that a provider with a provider ID of “aaa01” decides a price, using a function f(a) that indicates a price-decision algorithm expressed by the parameter “a”. The signature is an electronic signature of the provider with a provider ID of “aaa01”.

### (2) Measured-Value Transaction Data

FIG. 4 is an explanatory drawing schematically illustrating the measured-value transaction data according to the present embodiment. The measured-value transaction data is generated by terminal 42 possessed by measured-value provider X2 and transmitted to the servers such as 10A, for example when measured-value provider X2 provides a measured value measured at regular time intervals.

As illustrated in FIG. 4, the measured-value transaction data includes a provider ID, a measurement position, a measuring time, a measured value, and a signature.

The provider ID is an identifier for uniquely identifying a provider that provides the measured value.

The measurement position is information indicating a position at which the measured value is measured. The measurement position may, for example, be indicated by latitude and longitude, or may be indicated by address.

The measuring time is information indicating a time when the measured value is measured. While the measuring time indicates the time when the measured value is measured, it may indicate a time period including the time of measurement.

The measured value is a value of the parameter used in the price-decision algorithm at the measurement position and at the measuring time. In the case where the parameter indicates the weather, the measured value may be expressed by integers from 1 to 5 as described in the above example. In the case where the parameter indicates demand, the measured value may be the number of persons who use the variable-price service in a predetermined region including the measurement position and in a predetermined time period including the measuring time.

In the case where the parameter indicates supply, the measured value may be the number of variable-price services available in a predetermined region including the measurement position and in a predetermined time period including the measuring time. In the case where the variable-price service is a vehicle distribution service, the measured value may be the number of vehicles that can be distributed in a predetermined region and in a predetermined time period. In the case where the variable-price service is a service for selling performance tickets such as movie tickets, theatre tickets, or concert tickets, the measured value may be the number of tickets that can be sold for one performance designated by a user.

The signature is an electronic signature signed by a device or human that has generated the measured-value transaction data.

The measured-value transaction data illustrated in FIG. 4 is measured-value transaction data that enables a provider with a provider ID of “bbb01” to provide a measured value obtained by measurement. This measured value is provided at a measurement position of “X1, Y1” and at a measuring time of “2020.04.10 10:05”, and the measured value is “4”. The signature is an electronic signature of the provider with the provider ID of “bbb01”.

### (3) Price Transaction Data

FIG. 5 is an explanatory drawing schematically illustrating the price transaction data according to the present embodiment. The price transaction data is generated by terminal 41 possessed by service provider X1 and transmitted to the servers such as 10A, for example when service provider X1 provides a decided price for a service for which user U1 is applied.

As illustrated in FIG. 5, the price transaction data includes a provider ID, a location, a time, a measured value, a price, and a signature.

The provider ID is an identifier for uniquely identifying a provider that provides the variable-price service.

The location is information indicating a location where the variable-price service is offered to user U1. Note that the location may be information indicating a position at which user U1 has applied for the variable-price service. For example, the location may be the location of terminal 40 detected by terminal 40 when terminal 40 has received input of an application from user U1.

The time is information indicating a time when user U1 has applied for the variable-price service. For example, the time may be a time when terminal 40 has received input of an application from user U1.

The measured value is a value of the parameter applied to the price-decision algorithm in order to decide a price. For example, the measured value is information indicating a measured value of the parameter that is specified by the location and the time described above. That is, the measured value is information indicating a measured value of the parameter that is specified by the location and the time where and when the variable-price service is to be offered to user U1. The measured value may be information indicating a measured value of the parameter that is specified by the location and the time where and when user U1 has applied for the variable-price service.

The price is a price decided (calculated) by applying the measured value to the price-decision algorithm.

The signature is an electronic signature signed by a device or human that has generated the price transaction data.

In the case where there are a plurality of measured-value providers, the price transaction data may further include a measured-value provider ID that serves as an identifier for uniquely identifying a provider that has measured the measured value to be applied to the price-decision algorithm in order to decide a price.

The price transaction data illustrated in FIG. 5 is price transaction data for providing a notification of a price for the variable-price service provided by a provider with a provider ID of “aaa01” at a location of “X1, Y1” and at a time of “2020.04.10 10:05”. This notification of the price indicates that the price is “20” and the measured value of the parameter used to decide the price is “4”. The signature is an electronic signature of the provider with the provider ID of “aaa01”.

### (4) Payment Transaction Data

FIG. 6 is an explanatory drawing schematically illustrating the payment transaction data according to the present embodiment. The payment transaction data is generated by terminal 40 possessed by user U1 and transmitted to the servers such as 10A when user U1 pays the price for (a charge for using) the variable-price service.

As illustrated in FIG. 6, the payment transaction data includes a payer ID, a payment destination ID, a payment date and time, a payment amount, and a signature.

The payer ID is an identifier for uniquely identifying a payer for payment.

The payment destination ID is an identifier for uniquely identifying a payment destination for the payment.

The payment date and time are information indicating timing of the payment. The payment date and time indicate the date and time of a payment transaction, but it is not an absolute necessarily to indicate the time of the transaction, and only the date, out the date and time, may be indicated by the information.

The payment amount is information indicating the amount of payment. The payment amount may, for example, be the amount of tokens.

The signature is an electronic signature signed by a device or human that has generated the payment transaction data.

The payment transaction data illustrated in FIG. 6 is payment transaction data indicating a payment transaction in which a payer with a payer ID of “ccc01” make payment to a payment destination with a payment destination ID of “aaa01”. In this transaction, the payment amount is “20” tokens and the payment date and time are “2020.04.10 10:10”. The signature is an electronic signature of the payer.

Three specific examples of the processing performed in price decision system 1 will be described hereinafter.

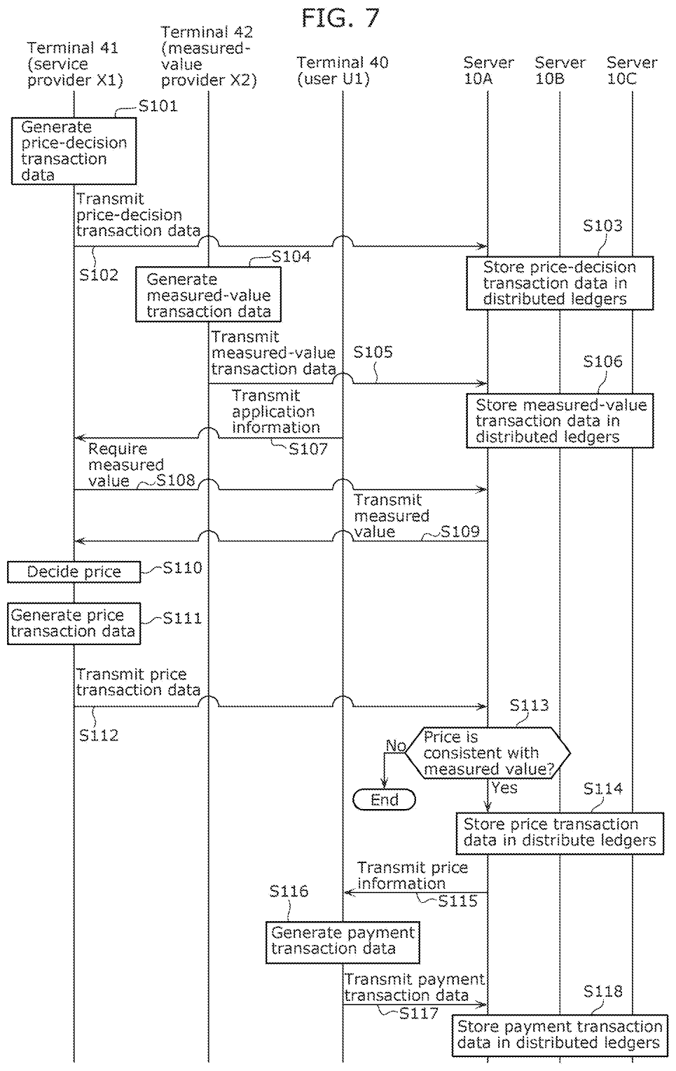

FIG. 7 is a sequence diagram illustrating a first example of the processing performed in price decision system 1 according to the present embodiment.

Terminal 41 possessed by service provider X1 generates price-decision transaction data (S101). For example, terminal 41 receives, from service provider X1, input of the type of the parameter and the relationship between the parameter and the price and generates price-decision transaction data in response to the received input.

Terminal 41 transmits the generated price-decision transaction data to the servers such as 10A (S102). At this time, terminal 41 may transmit the generated price-decision transaction data to one of the servers such as 10A or to a plurality of servers.

The servers such as 10A receive the price-decision transaction data transmitted from terminal 41 and stores the received price-decision transaction data into their respective distributed ledgers (S103).

Note that steps S101 to S103 may be performed at regular time intervals, or may be performed only when service provider X1 has determined or altered a price-decision algorithm.

Meanwhile, terminal 42 possessed by measured-value provider X2 generates measured-value transaction data (S104). For example, terminal 42 receives input that includes a detection result obtained by a sensor (not shown) or input from a measurer and generates measured-value transaction data in accordance with the received input.

Terminal 42 transmits the generated measured-value transaction data to the servers such as 10A (S105). At this time, terminal 42 may transmit the generated measured-value transaction data to one of the servers such as 10A or to a plurality of servers.

The servers such as 10A receive the measured-value transaction data transmitted from terminal 42 and store the received measured-value transaction data into their respective distributed ledgers (S106).

Note that steps S104 to S106 are performed at regular time intervals.

Next, terminal 40 possessed by user U1 transmits, to terminal 41, application information generated by receiving input of application for using the variable-price service from user U1 (S107).

Terminal 41 that has received the application information transmits request information included in the application information to server 10A, the request information being information for requesting the servers such as 10A to provide a measured value at the time of application and at the location where the variable-price service is to be offered to user U1 (S108).

The servers such as 10A that have received the request information transmits the measured value at the time of application and at the location where the variable-price service is to be offered to user U1, to terminal 41 in accordance with the request information (S109). The measured value to be transmitted is specified from among the measured-value transaction data already stored in the distributed ledger.

Terminal 41 that has received the measured value applies the received measured value to the price-decision algorithm so as to decide a price for the variable-price service applied for by user U1 (S110). The price-decision algorithm as used herein is the same as the price-decision algorithm included in the price-decision transaction data generated by terminal 41 in step S101.

Next, terminal 41 generates price transaction data including the decided price (S111).

Terminal 41 transmits the generated price transaction data to the servers such as 10A (S112). At this time, terminal 41 may transmit the generated price transaction data to one of the servers such as 10A or to a plurality of servers.

Upon receiving the price transaction data, The servers such as 10A that have received the price transaction data determine whether the price decided by terminal 41 and included in the received price transaction data matches or mismatches with the measured value included in the measured-value transaction data and used as a basis by terminal 41 to decide the price (S113). The example in which server 10A performs the processing of step S113 is illustrated in FIG. 7, but other servers may perform the processing of step S113. For example, all of a plurality of servers included in the servers such as 10A may perform the processing of step S113, or only some of the servers may perform the processing of step S113. For example, a server that has finished the determination in S113 may transmit the determination result to other servers. When the other servers that have received such determination result have not yet transmitted their respective determination results to other servers excluding themselves, these servers do not necessarily have to transmit their respective detection results to other servers excluding themselves.

When it is determined that the price matches with the measured value (Yes in S113), the servers such as 10A store the received price transaction data into their respective distributed ledgers (S114). When it is determined that the price does not match with the measured value (No in S113), the servers such as 10A suspend the processing for offering the variable-price service and ends the procedure. That is, in this case, the price transaction data is not stored into the distributed ledgers.

The servers such as 10A transmit price information indicating the price included in the received price transaction data to terminal 40 possessed by user U1 (S115). At this time, not all of a plurality of servers included in servers such as 10A have to transmit the price information to terminal 40. For example, a server that has completed the storing of the price transaction data may transmit completion information indicating the completion of transmission of the price information to other servers, in addition to transmitting the price information to terminal 40. When the other servers that have received the completion information have not yet transmitted the price information to terminal 40, these servers do not necessarily have to transmit the price information to terminal 40.

Terminal 40 that has received the price information generates payment transaction data (S116). Note that, upon receiving the price information, terminal 40 may cause the price included in the price information to be displayed on terminal 40 and may present a user interface (UI) for inquiring of user U1 whether or not to consent to the price included in the price information. When input indicating consent is received, terminal 40 generates payment transaction data including the date and time when the input is received and a payment amount that is the same amount as the price. On the other hand, if input indicating dissent is received or if input indicating consent has not been received for a fixed time period, terminal 40 may suspend the processing related to payment. In this case, terminal 40 may transmit termination information indicating the termination of the processing to the servers such as 10A. The servers such as 10A that has received the termination information stop and end the processing related to payment. Note that the servers such as 10A may stop processing related to the transaction not only when the termination information has been received but also when any information (e.g., payment transaction data) has not been received for a certain time period from terminal 40 after the transmission of the price information.

After step S116, terminal 40 transmits the generated payment transaction data to the servers such as 10A (S117). At this time, terminal 40 may transmit the generated payment transaction data to one of the servers such as 10A or to a plurality of servers.

The servers such as 10A receive the payment transaction data transmitted from terminal 40 and store the payment transaction data into their respective distributed ledgers (S118).

Thereafter, the servers such as 10A may notify terminal 41 of service provider X1 about the fact that user U1 has paid the payment amount included in the payment transaction data at the payment date and time.

Note that a set of steps S101 to S103 and a set of steps S104 to S106 may be conducted independently of each other. Steps S101 to S103 may be conducted after steps S104 to S106.

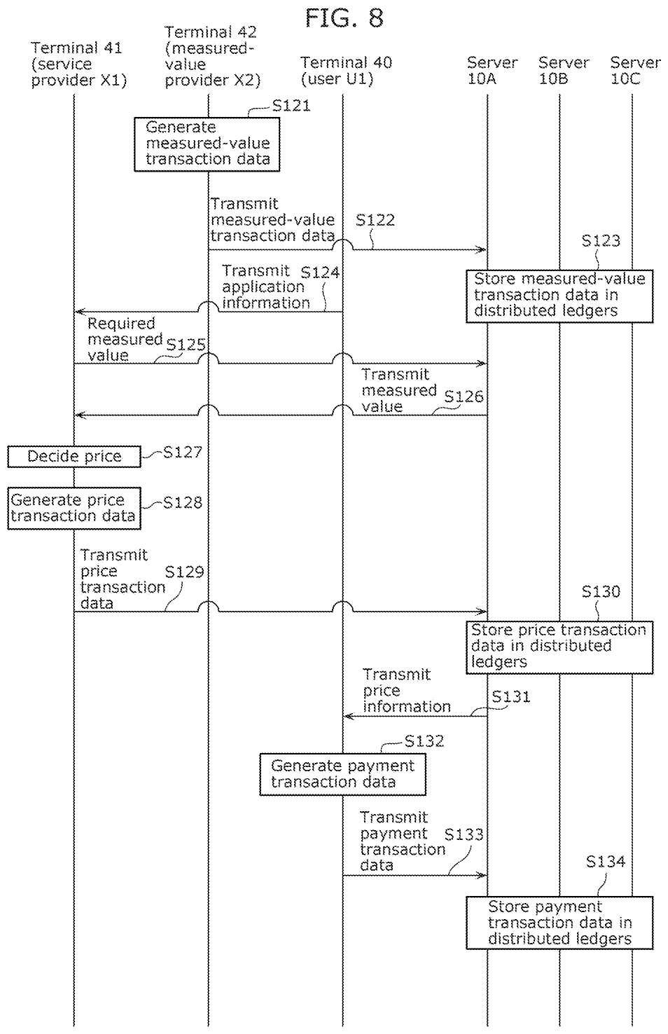

FIG. 8 is a sequence diagram illustrating a second example of the processing performed in price decision system 1 according to the present embodiment.

In the second example, unlike in the first example, terminal 41 does not transmit the price-decision transaction data to the servers such as 10A. Besides, the servers such as 10A do not determine a match or mismatch of measured values.

First, terminal 42 possessed by measured-value provider X2 generates measured-value transaction data (S121) and transmits the generated measured-value transaction data to the servers such as 10A (S122).

The servers such as 10A receive the measured-value transaction data transmitted from terminal 42 and store the received measured-value transaction data into their respective distributed ledgers (S123).

Note that steps S121 to S123 are respectively the same processing as steps S104 to S106.

Next, terminal 40 transmits application information to terminal 41 (S124).

Terminal 41 that has received the application information transmits request information to server 10A (S125).

The servers such as 10A that have received the request information transmit a measured value to terminal 41 in accordance with the request information (S126).

Terminal 41 that has received the measured value determines a price for a variable-price service for which user U1 had applied (S127).

Next, terminal 41 generates price transaction data including the decided price (S128) and transmits the generated price transaction data to the servers such as 10A (S129).

Note that steps S124 to S129 are respectively the same processing as steps S107 to S112.

The servers such as 10A that have received the price transaction data stores the received price transaction data into their respective distributed ledgers (S130).

The servers such as 10A transmits price information that indicates a price included in the received price transaction data, to terminal 40 possessed by user U1 (S131).

Terminal 40 that has received the price information generates payment transaction data (S132).

After step S132, terminal 40 transmits the generated payment transaction data to the servers such as 10A (S133).

The servers such as 10A receive the payment transaction data transmitted from terminal 40 and stores the payment transaction data into their respective distributed ledgers (S134).

Note that steps S130 to S134 are respectively the same processing as steps S114 to S118.

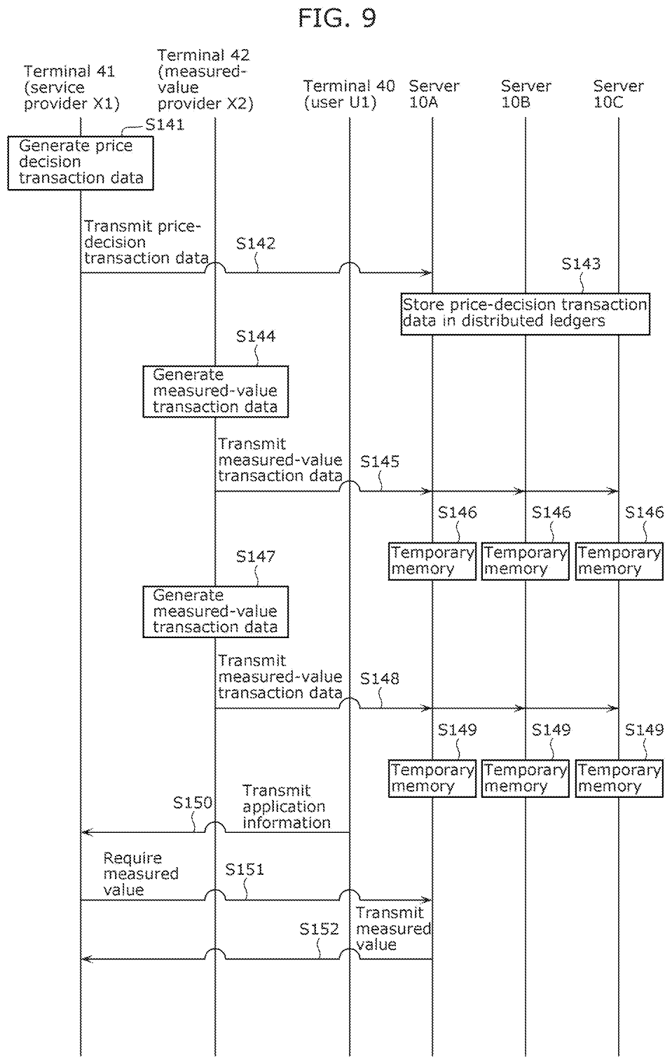

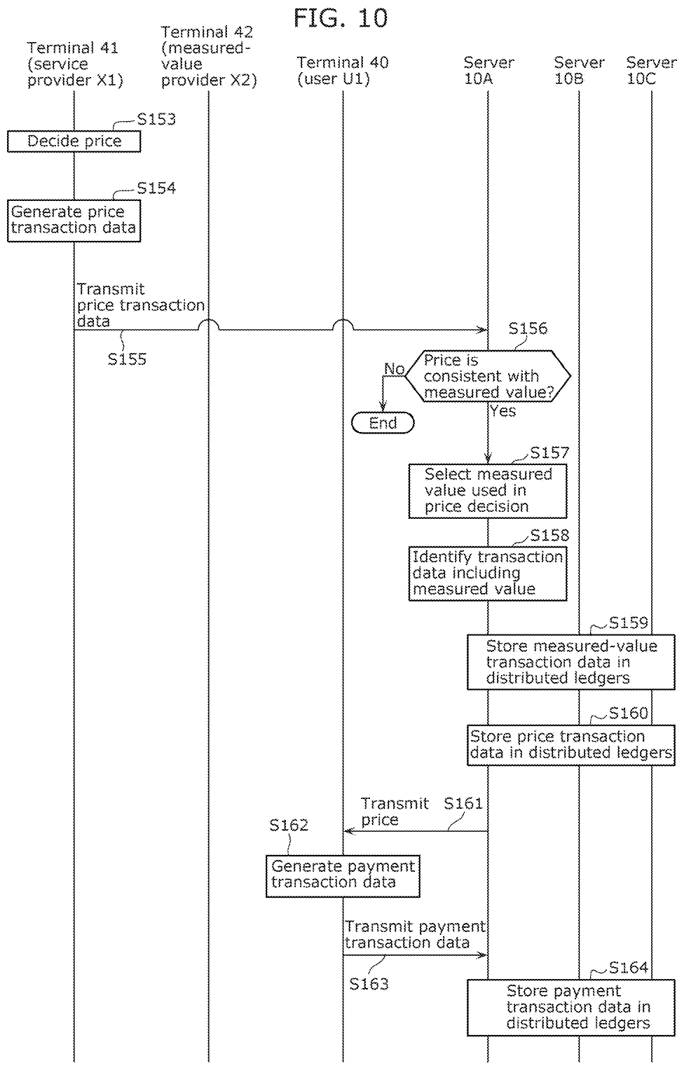

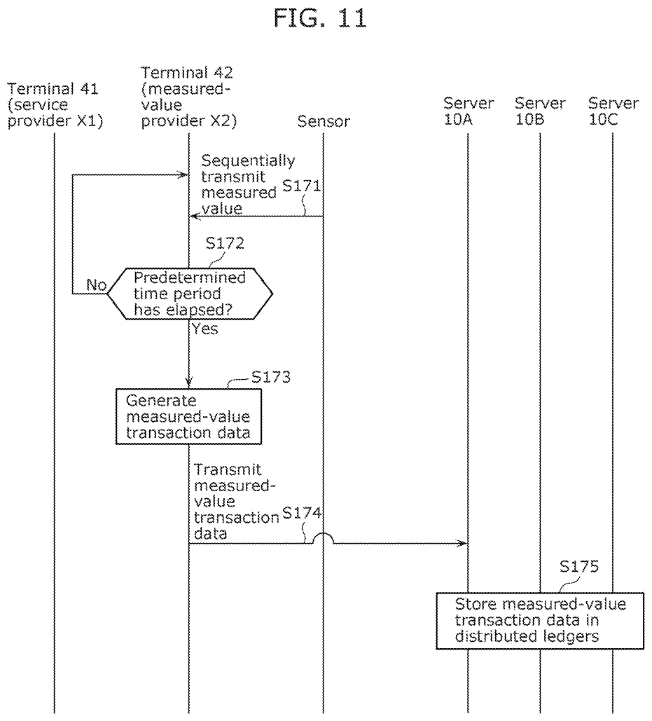

FIGS. 9 and 10 are sequence diagrams illustrating a third example of the processing performed in price decision system 1 according to the present embodiment. Note that FIG. 10 is a sequence diagram following the sequence diagram in FIG. 9.

In the third example, unlike in the first example, the servers such as 10A do not store all measured-value transaction data items received from terminal 42 into the distributed ledgers and instead store only some specific some of the measured-value transaction data into their respective distributed ledgers.

Terminal 41 possessed by service provider X1 generates price-decision transaction data (S141) and transmits the generated price-decision transaction data to the servers such as 10A (S142).

The servers such as 10A receive the price-decision transaction data transmitted from terminal 41 and store the received price-decision transaction data into their respective distributed ledgers (S143).

Note that steps S141 to S143 are respectively the same processing as steps S101 to S103.

Meanwhile, terminal 42 possessed by measured-value provider X2 generates measured-value transaction data (S144) and transmit the generated measured-value transaction data to the servers such as 10A (S145).

Note that steps S144 and S145 are respectively the same processing as steps S104 and S105.

The servers such as 10A receive the measured-value transaction data transmitted from terminal 42 and temporarily stores the received measured-value transaction data into the memories of the servers such as 10A (S146). The memory may, for example, b a non-volatile memory.

Then, steps S147 to S149 that are similar processing to steps S144 to S146 are repeated. The processing in steps S144 to S146 are repeated at regular time intervals, and may be repeated three times or more.

Next, terminal 40 transmits application information to terminal 41 (S150).

Terminal 41 that has received the application information transmits request information to server 10A (S151).

The servers such as 10A that has received the request information transmits a measured value to terminal 41 in accordance with the request information (S152). The measured value to be transmitted is specified from among the measured-value transaction data temporarily stored in the memory.

Terminal 41 that has received the measured value determines a price for a variable-price service for which user U1 has been applied (S153).

Next, terminal 41 generates price transaction data that includes the decided price (S154) and transmits the generated price transaction data to the servers such as 10A (S155).

The servers such as 10A that have received the price transaction data determine whether the price decided by terminal 41 matches or mismatches with the measured value used as a basis by terminal 41 to decide the price (S156).

Note that steps S150, S151, and S153 to S156 are respectively the same processing as steps S107, S108, and S110 to S113.

When it is determined that the price matches with the measured value (Yes in S156), the servers such as 10A select the measured value used to decide the price (S157) and specifies measured-value transaction data including the selected measured value and temporarily stored in the memory (S158).

Although the case in which server 10A performs processing in steps S156 to S158 is illustrated in FIG. 10, this processing may be performed by other servers. For example, the processing in steps S156 to S158 may be performed by all of a plurality of servers included in the servers such as 10A, or may be performed by only some of the servers. For example, a server that has completed the processing in steps S156 to S158 may transmit a processing result to other servers. When the other servers that have received the processing result have not yet transmitted their respective processing results to other servers excluding themselves, these servers do not necessarily have to transmit their respective processing results to other servers excluding themselves.

Then, the servers such as 10A store the specified measured-value transaction data into their respective distributed ledgers (S159).

Next, the servers such as 10A store the received price transaction data into their respective distributed ledgers (S160).

The servers such as 10A transmit the price information indicating the price included in the received price transaction data to terminal 40 possessed by user U1 (S161).

Terminal 40 that have received the price information generates payment transaction data (S162).

After step S162, terminal 40 transmits the generated payment transaction data to the servers such as 10A (S163).

The servers such as 10A receive the payment transaction data transmitted from terminal 40 and store the payment transaction data into their respective distributed ledgers (S164).

Note that steps S160 to S164 are respectively the same processing as steps S114 to S118.

Next is a description of specific examples of the processing for storing measured-value transaction data into the distributed ledgers in the processing performed in price decision system 1 according to the present embodiment.

FIG. 11 is a sequence diagram illustrating a first example of processing for generating measured-value transaction data according to the present embodiment. The first example is an example in which measured-value transaction data including one or more measured values measured in predetermined units of time is transmitted from terminal 42 to the servers such as 10A.

First, a sensor obtains measured values at regular time intervals and transmits the obtained measured values in succession to terminal 42 (S171). The sensor may transmit the measured values to terminal 42 over network N, or may transmit the measured values to terminal 42 over a dedicated network. The sensor may, for example, be a sensor that detects a rainfall per unit time.

Alternatively, terminal 42 may receive results of measurement conducted by a measurer as measured values from a terminal that receives input from the measurer, instead of receiving measured values from the sensor. As another alternative, terminal 42 may also receive measured values from an external information terminal, instead of receiving measured values from the sensor.

Terminal 42 determines whether or not a predetermined period of time has elapsed from predetermined timing (S172). The predetermined timing may, for example, be a staring time of terminal 42, or may be a time when previous measured-value transaction data has been generated. Note that the predetermined period of time may, for example, be a duration of time such as five minutes or ten minutes.

When it is determent that a predetermined period of time has elapsed (Yes in S172), terminal 42 generates measured-value transaction data including one or more measured values received from the sensor before a predetermined period of time has elapsed from the predetermined timing (S173).

Terminal 42 transmits the generated measured-value transaction data to the servers such as 10A (S174).

The servers such as 10A receive the measured-value transaction data transmitted from terminal 42 and store the received measured-value transaction data into their respective distributed ledgers (S175).

Note that steps S171 to S175 are repeatedly performed every a predetermined period of time.

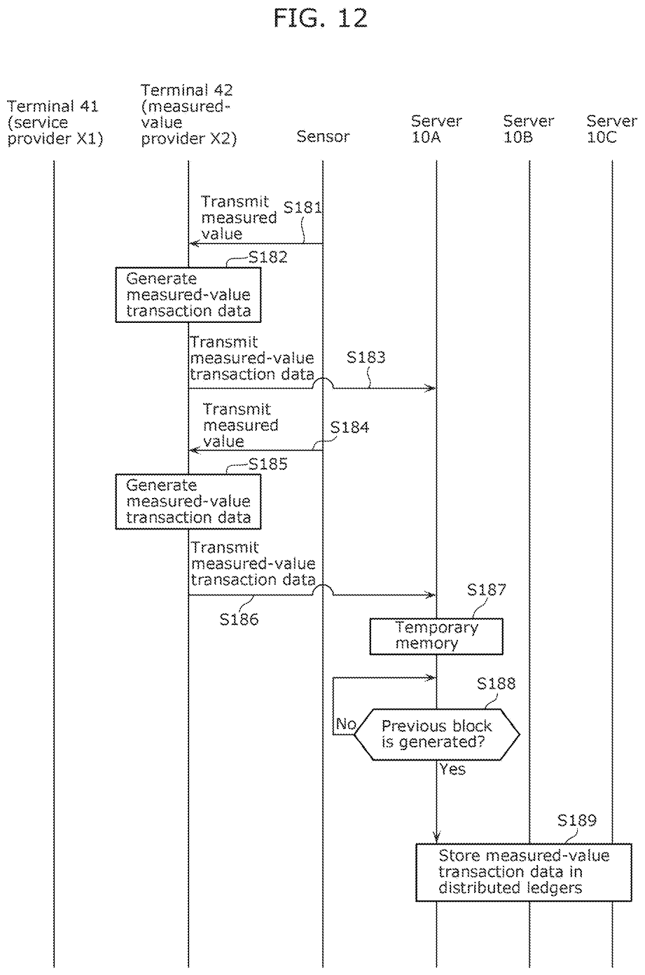

FIG. 12 is a sequence diagram illustrating a second example of the processing for generating measured-value transaction data according the present embodiment. The second example is an example in which measured-value transaction data is transmitted from terminal 42 to the servers such as 10A at time intervals shorter than time intervals of generating a block.

First, a sensor obtains a measured value at regular time intervals and transmits the obtained measured value to terminal 42 (S181). The sensor as used herein may be similar to the sensor in FIG. 11, or may be a terminal that receives input from a measurer, instead of the sensor, or may be an external information terminal.

Terminal 42 that has received the measured value from the sensor generates measured-value transaction data including the received measured value (S182) and transmits the generated measured-value transaction data to the servers such as 10A (S183).

Then, steps S184 to S186 that are similar processing to steps S181 to S183 are repeated. The processing in steps S181 to S183 is repeated at regular time intervals, and may be repeated three times or more.

The servers such as 10A that have received the measured-value transaction data temporarily store the measured-value transaction data into their respective memories every time the measured-value transaction data has been received (S187).

The servers such as 10A determine whether or not the previous block to be stored into the distributed ledgers has been generated (S188).

When it is determined that the previous block has been generated (Yes in S188), the servers such as 10A store measured-value transaction data that is to be generated as a block next to the previous block, out of one or more temporarily stored transaction data items, into their respective distributed ledgers (S189).

Although the example in which server 10A performs the processing in steps S187 and S188 is illustrated in FIG. 12, this processing may be performed by other servers. For example, the processing in steps S187 and S188 may be performed by all of a plurality of servers included in the servers such as 10A, or may be performed by only some of the servers. For example, a server that has completed the determination in S188 may transmit a determination result to other servers. When the other servers that have received the detection result have not yet transmitted their respective determination results to other servers excluding themselves, these servers do not necessarily have to transmit their respective determination results to other servers excluding themselves.

As described above, in the control method according to the present embodiment, the servers such as 10A transfer measured-value transaction data including a measured value to other servers and store a block including the measured-value transaction data into their respective distributed ledgers. Thus, for example, even if measured values are provided from a plurality of terminals 42, it is possible to collectively manage the measured values. Since the measured-value transaction data is transferred to other servers, it is possible to reduce the possibility of loss of measured values. Accordingly, it is possible to effectively manage records of measured values.

The storing of the block into the distributed ledgers is implemented through the execution of the consensus algorithm. Accordingly, the control method according to the present embodiment can properly manage measured values with more ease through the execution of the consensus algorithm.

The storing of the block into the distributed ledgers is implemented through the verification of the correctness. Accordingly, the control method according to the present embodiment can more properly manage measured values through the verification of the correctness.

The servers such as 10A transfer price transaction data including a decided price to other servers and store a block including the price transaction data into their respective distributed ledgers. Accordingly, the control method according to the present embodiment can properly manage the decided price.

When it is determined that the price does not match with the measured value, the servers such as 10A do not store a block including price transaction data into their respective distributed ledgers. This reduces the possibility that price transaction data including an inappropriate price is stored into the distributed ledgers. Since the price transaction data including an inappropriate price is not stored into the distributed ledgers, it is possible to reduce the storage capacities of the distributed ledgers.

Besides, only for measured-value transaction data that corresponds to the measured value used to calculate the price out of a plurality of measured-value transaction data items, a block including the measured-value transaction data is stored into the distributed ledgers. That is, measured-value transaction data that includes a measured value not used to calculate the price is not stored into the distributed ledgers. Accordingly, it is possible to reduce the storage capacities of the distributed ledgers.

The servers such as 10A transfer, to other servers, payment transaction data including the amount of tokens related to the payment of a price presented and store a block including the payment transaction data into their respective distributed ledgers. Accordingly, it is possible to properly manage the amount of tokens that have been paid.

The servers such as 10A transfer price-decision transaction data including a price-decision algorithm to other servers and store a block including the price-decision transaction data into their respective distributed ledgers. Accordingly, it is possible to properly manage the price-decision algorithm.

### Variation 1

In the control method according to the above-described embodiment, terminal 41 possessed by service provider X1 decides a price, but the present disclosure is not limited to this example, and the servers such as 10A may decide a price. For example, in the first or third example of the processing performed in the price decision system, the servers such as 10A store price-decision transaction data including a price-decision algorithm into their respective distributed ledgers.

For example, terminal 41 transmits application information received from terminal 40 of user U1 to the servers such as 10A.

Then, the servers such as 10A that have received the application specifies a measured value at a location where the variable-price service is offered to user U1 and at a time of application, the location and the time being included in the application information of user U1, from among already stored measured-value transaction data.

Then, the servers such as 10A may apply the specified measured value to a price-decision algorithm included in the price-decision transaction data already stored, so as to decide a price for the variable-price service for which user U1 is applied.

Note that the servers such as 10A do not necessarily have to receive application information from terminal 41, and may receive application information from a terminal of user U1.

### Variation 2

This variation describes another configuration of the price decision system according to the above-described embodiment.

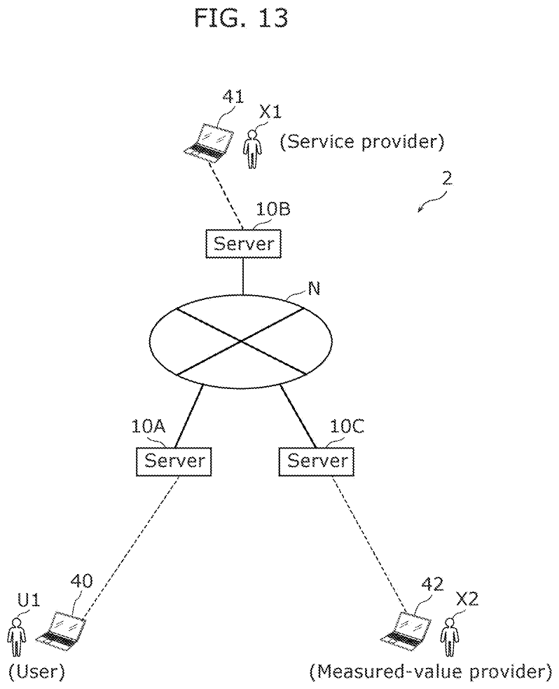

FIG. 13 is a block diagram schematically illustrating a configuration of price decision system 2 according to Variation 2.

As illustrated in FIG. 13, price decision system 2 includes servers 10A, 10B, and 10C and terminals 40, 41, and 42. Each device included in price decision system 2 is communicably connected to the other devices over network N. Network N may be configured using any communication circuit or any network and includes, for example, the Internet or carrier networks for mobile phones.

In particular, in price decision system 2, servers 10A, 10B, and 10C are connected to one another over network N. Moreover, server 10A is connected to terminal 40, server 10B is connected to terminal 41, and server 10C is connected to terminal 42.

This configuration may be used, for example, when price decision system 2 is operated by a plurality of groups, and servers managed by the respective groups are connected to one another over network N. For example, server 10A and terminal 40 belong to group A, server 10B and terminal 41 belong to group B, and server 10C and terminal 42 belong to group C.

The operations of the servers such as 10A and the terminals such as 40 are similar to the operations in the case of the above-described embodiment, and therefore a description thereof shall be omitted.

### Variation 3

This variation describes another configuration of the price decision system according to the above-described embodiment.

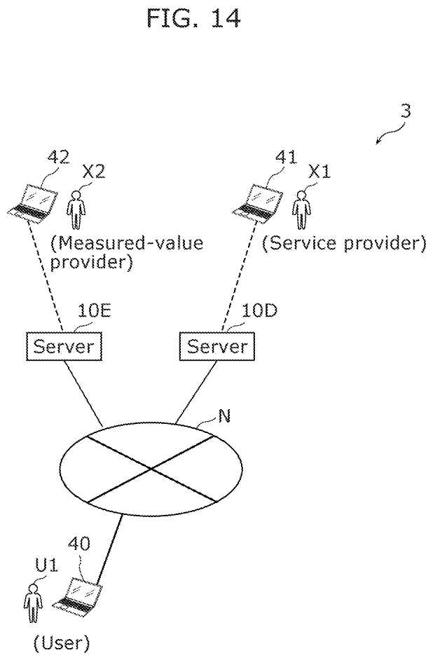

FIG. 14 is a block diagram schematically illustrating a configuration of price decision system 3 according to Variation 3.

As illustrated in FIG. 14, price decision system 3 includes server 10D, 10E and terminals 40, 41, and 42. Each device included in price decision system 3 is communicably connected to the other devices over network N. Network N may be configured using any communication circuit or any network and include, for example, the Internet or carrier networks for mobile phones.

In particular, in price decision system 3, servers 10D and 10E and terminal 40 are connected to one another over network N. Moreover, server 10D is connected to terminal 41, and server 10E is connected to terminal 42. In this case, each of servers 10D and 10E and terminal 40 operates like the servers such as 10A according to the above-described embodiment.

This configuration may be used, for example, when price decision system 3 is operated by one or more groups and one or more individuals, and a server or a terminal managed by each group or individual is connected to the others over network N. For example, server 10D and terminal 41 belong to group D, server 10E and terminal 42 belong to group E, and price decision system 3 is operated by groups D and E and user U1, i.e., an individual.

The operations of the servers such as 10A and the terminals such as 40 are similar to the operations described in the above-described embodiment, and therefore a detailed description thereof shall be omitted.

### Variation 4

Here, Variation 4 will be described.

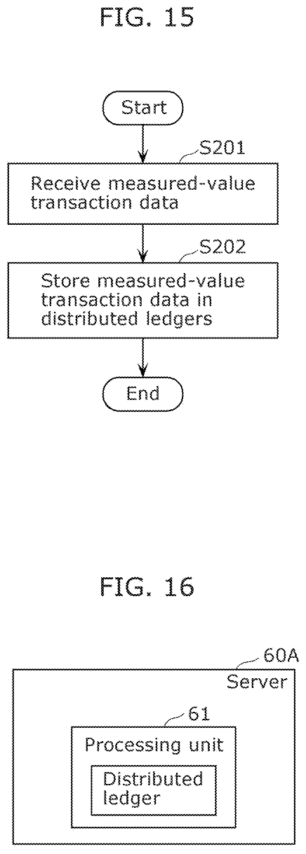

FIG. 15 is a flowchart illustrating processing performed by a server according to Variation 4.

As illustrated in FIG. 15, the servers such as 10A receive measured-value transaction data from terminal 42 over network N, terminal 42 providing a measured value corresponding to each of one or more parameters for determining a price for a variable-price service, and the measured-value transition data including one or more parameters, a measured value corresponding to each of the one or more parameters, and a location and a time where and when each measured value has been obtained (S201).

Each of servers 10A to 10C transfers the received measured-value transaction data to other servers among servers 10A to 10C and store a block including the measured-value transaction data into the distributed ledger managed by each of servers 10A to 10C (S202).

Accordingly, for example even if measured values are provided from a plurality of terminals 42, it is possible to collectively manage the measured values. Since the measured-value transaction data is transferred to other servers, it is possible to reduce the possibility of loss of measured values. Accordingly, it is possible to effectively manage records of measured values.

FIG. 16 is a block diagram schematically illustrating a configuration of a server according to Variation 4.

As illustrated in FIG. 16, in a transaction management system including a plurality of servers each possessing a distributed ledger, one server 60A among the plurality of servers includes processing unit 61.

Processing unit 61 receives measured-value transaction data from terminal 42 over network N, terminal 42 providing a measured value corresponding to each of one or more parameters for determining a price for a variable-price service, and the measured-value transaction data including one or more parameters, a measured value corresponding to each of the one or more parameters, and a location and a time where and when each measured value has been obtained.

Processing unit 61 transfers the received measured-value transaction data to other servers different from server 60A and stores a block including the measured-value transaction data into the distributed ledger of processing unit 61.

Accordingly, for example, even if measured values are provided from a plurality of terminals 42, it is possible to collectively manage the measured values. Since the measured-value transaction data is transferred to other servers, it is possible to reduce the possibility of loss of measured values. Accordingly, it is possible to effectively manage records of measured values.

### SUPPLEMENTAL REMARKS

Supplemental remarks are given on the block chain according to the above-described embodiment and variations.

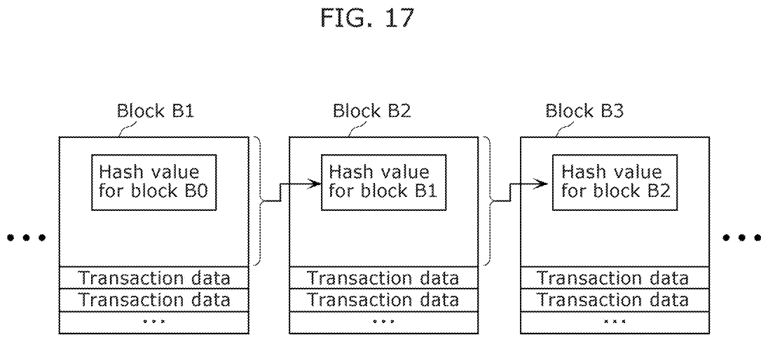

FIG. 17 is an explanatory drawing illustrating a data structure of a block chain.

The block chain is configured by connecting blocks, which are units of recording, in a chain. Each block includes a plurality of transaction data items and a hash value for the next previous block. Specifically, block B2 includes the hash value for the next previous block B1. Then, a hash value that is computed from the hash value for block B1 and a plurality of transaction data items included in block B2 is included in block B3 as a hash value for block B2. In this way, blocks are connected in a chain while including the contents of previous blocks as hash values. This effectively prevents tampering with recorded transaction data.

When past transaction data has been changed, hash values for blocks become different from the values before the change, and in order to make the tampered blocks look like correct ones, it is necessary to recreate all subsequent blocks after the change. In practice, this operation is very difficult. Difficulty in tempering with the block chain is ensured using this characteristic.

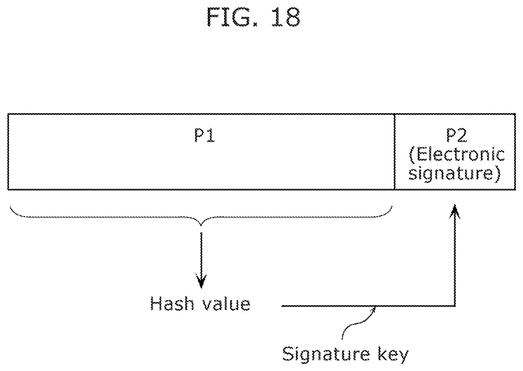

FIG. 18 is an explanatory drawing illustrating a data structure of transaction data.

The transaction data illustrated in FIG. 18 includes transaction body P1 and electronic signature P2. Transaction body P1 is a data body included in the transaction data. Electronic signature P2 is generated by signing a hash value for transaction body P1 with a signature key of the creator of the transaction data, and more specifically, by encrypting the hash value with a secret key of the creator.

The transaction data is substantially impossible to tamper because electronic signature P2 is included in the transaction data. This prevents tampering with the transaction body.

Each element in the above-described embodiment may be configured in the form of an exclusive hardware product, or may be realized by executing a software program suitable for the element. Each element may be realized by means of a program executing unit, such as a CPU and a processor, reading and executing a software program recorded on a recording medium such as a hard disk or a semiconductor memory. The software program as used herein, which realizes the content management system or the like according to the above-described embodiment, is a program described below.

Specifically, the program causes a computer to execute a control method that is implemented by one server out of a plurality of servers, each managing a distributed ledger. The control method includes receiving first transaction data from a measured-value server over a network, the measured-value server providing a measured value corresponding to each of one or more parameters for determining a price for a variable-price service, and the first transaction data including the one or more parameters, a measured value corresponding to each of the one or more parameters, and a location and a time where and when the measured value is obtained, and storing a first block including the first transaction data into a first distribute ledger managed by the one server.

While the price decision system and the like according to one or a plurality of aspects of the present disclosure have been described thus far based on the embodiment, the present disclosure is not intended to be limited to this embodiment. The present disclosure also includes other embodiments such as those obtained by making various modifications conceivable by a person skilled in the art to the above-described embodiment, and those obtained by arbitrarily combining any of the constituent elements and functions in the above-described embodiment within a scope that does not depart from the gist of the present disclosure.

### INDUSTRIAL APPLICABILITY

The present disclosure is applicable to a price decision system that enables effectively managing records of measured values.

1. A control method that is executed by one server out of a plurality of servers each managing a distributed ledger, the control method comprising:
receiving first transaction data from a measured-value server over a network, the measured-value server providing, for each of one or more parameters for determining a price for a variable-price service, a measured value that corresponds to the parameter, and the first transaction data including the one or more parameters, the measured value, and a location and a time when and where the measured value is obtained; and
transferring the first transaction data received to other servers out of the plurality of servers and storing a first block including the first transaction data into a first distributed ledger managed by the one server.

2. The control method according to claim 1,
wherein the storing of the first block into the first distributed ledger includes executing a consensus algorithm together with the other servers and storing the first block into the first distributed ledger.

3. The control method according to claim 1, further comprising:
verifying an electronic signature associated with the measured-value server and correctness of the first transaction data in the first transaction data received; and
when the verifying of the electronic signature and the correctness of the first transaction data is successful, executing the storing of the first block into the first distributed ledger.

4. The control method according to claim 1, further comprising:
receiving second transaction data from a distribution server over the network, the distribution server offering the variable-price service, and the second transaction data including a first price presented on a terminal of a user who uses the variable-price service, a first measured value used to decide the first price, and a first location and a first time where and when the first measured value is obtained; and
transferring the second transaction data received to the other servers and storing a second block including the second transaction data into the first distributed ledger.

5. The control method according to claim 4, further comprising:
determining whether the first price included in the second transaction data received matches or mismatches with a measured value associated with the first location and the first time in the first transaction data stored in the first distributed ledger; and
storing the second block into the first distributed ledger when it is determined that the first price matches with the measured value, and
skipping storing of the second block into the first distributed ledger when it is determined that the first price does not match with the measured value.

6. The control method according to claim 5,
wherein the first transaction data is received at different times,
a plurality of first transaction data items received at the different times, the first transaction data items each being the first transaction data, include a plurality of measured values obtained at different locations and at different times,
the control method further comprising:
temporarily storing the plurality of first transaction data items received into a predetermined storage area in succession,
the determining being performed after the temporarily storing of the plurality of first transaction data items, and
when it is determined in the determining that the first price matches with the measured value,
specifying, from among the plurality of first transaction data items stored temporarily in the predetermined storage area, a first transaction data item that includes a second measured value corresponding to the first location and the first time that are included in the second transaction data, and
the storing of the first block includes storing a first block including the first transaction data specified, into the first distributed ledger.

7. The control method according to claim 4, further comprising:
transmitting presentation information for causing the terminal to present the first price, to the terminal over the network;
receiving, from the terminal, third transaction data that includes an amount of token related to payment of the first price presented in the presentation information; and
transferring the third transaction data received to the other servers and storing a third block including the third transaction data into the first distributed ledger.

8. The control method according to claim 1, further comprising:
receiving fourth transaction data from a distribution server over the network, the distribution server providing the variable-price service, the fourth transaction data including the parameter and a price-decision algorithm that includes the parameter and that is for determining the price; and
transferring the fourth transaction data received to the other servers and storing a fourth block including the fourth transaction data into the first distributed ledger.

9. A server that is one server out of a plurality of servers each managing a distributed ledger, the server comprising:
a processor; and
a memory,
wherein, using the memory, the processor:
receives first transaction data from a measured-value server over a network, the measured-value server providing a measured value corresponding to each of one or more parameters for deciding a price for a variable-price service, and the first transaction data including the one or more parameters, the measured value corresponding to each of the one or more parameters, and a location and a time where and when the measured value is obtained; and
transfers the first transaction data received to other servers different from the one server out of the plurality of servers, and store a first block including the first transaction data into a first distributed ledger managed by the one server.

10. A non-transitory computer-readable recording medium for use in a computer, the recording medium having a computer program recorded thereon for causing the computer to execute the control method according to claim 1.
